(19) United States
(12) Patent Application Publication
(10) Pub. No.: US 2021/0141293 A1
(43) Pub. Date: May 13, 2021

(54) ARCA-STYLE PLATE WITH BUBBLE LEVELS

(71) Applicant: New Ideas Manufacturing Company, Englewood, CO (US)

(72) Inventors: David Clark, Morrison, CO (US); Nathan Kanner, Denver, CO (US)

(73) Assignee: New Ideas Manufacturing Company, Englewood, CO (US)

(21) Appl. No.: 16/679,525

(22) Filed: Nov. 11, 2019

(51) Int. Cl. G03B 17/56; G01C 9/32

(52) U.S. Cl. CPC G03B 17/561; G01C 9/32; G03B 17/566

(57) ABSTRACT

An arca-type camera mounting plate includes a back side with leveling displays for unobstructed viewing of the leveling displays when the camera is mounted. The leveling displays may include vertical and horizontal bubble levels.

### FIELD OF THE INVENTION

The present invention relates generally to an apparatus for mounting and leveling a camera on a stand.

### BACKGROUND

The Arca-Swiss style (or arca-type) plate is a widely used type of quick-release camera plate for use on tripod heads. The typical arca-type plate is machined aluminum which attaches to the bottom of a camera via a ¼-20 screw and measures 38 mm wide with a 45 degree dovetail at the back of the plate.

The plate interacts with an arca-type clamp which sits on top of a tripod head. The clamps work by moving a dovetailed rail in and out of the clamp body with either a screw knob or a lever to clamp down on the plate. This arrangement is considered a quick release as opposed to prior designs in which the cameras themselves were attached directly to the tripod head, which requires more effort to attach and remove.

Bubble levels may be used by photographers to line up shots in either landscape or portrait compositions. The bubble levels may be horizontal, vertical, or a bull's eye configuration.

Bubble levels may be provided in different arrangements on a tripod setup. For example, bubble level(s) can be included on an independent attachment that rests between the tripod and the mounting head. Alternatively, bubble levels may be incorporated into the head itself or on the top of one or more of the tripod legs.

These levels may be ineffective in certain situations due to the fact that they may be covered when the camera is mounted, or may be inaccurate because the tripod needs to be setup in a non-level position, e.g., in the case where the tripod head would be adjusted for composition.

Accordingly, it would be advantageous to provide a clearly viewable and accurate leveling system for use with a camera-tripod attachment system.

### SUMMARY

Aspects of the present invention provide a camera mounting plate providing leveling indicators for leveling a camera on a tripod mount in both vertical and horizontal orientations.

The camera mounting plate may be an arca-type plate, in which the back, vertical side of the plate includes a ridge to help secure the attached camera.

The leveling indicators may be horizontally- and vertically-oriented bubble levels provided on the back side of the plate such that the leveling indicators are facing the user in a way that is never blocked by the bulk of the camera.

The camera mounting plate according to the various embodiments ensure that as long as the plate level indicators are in line, by adjusting the tripod head and/or the tripod, the camera will be in the correct position.

### BRIEF DESCRIPTION OF THE DRAWINGS

FIG. 1 is a perspective view of an arca-type plate for mounting a camera to a tripod according to an embodiment.

FIG. 2 is an alternate view of the arca-type plate of FIG. 1.

FIG. 3 is a view of a camera mounted on the arca-type plate of FIG. 1.

FIG. 4 is a side view of the arca-type plate of FIG. 1 on a ballhead tripod mount.

### DETAILED DESCRIPTION

FIG. 1 shows an arca-type plate 100 for mounting a camera to a tripod or other stand according to an embodiment. The plate 100 includes a top surface 102 for receiving the bottom surface of a camera. The top surface of the plate may include rubberized (e.g., soft silicone) pads 104 to protect the bottom surface of the camera.

The camera may be attached to the plate using a standard ¼-20 screw 106. In an embodiment, the plate measures 38 mm wide, and with a 45 degree ridge/backstop 108 at the back of the plate 110 to prevent the camera from slipping or rotating during use.

The back of the plate 110 may include a horizontal recess to hold a horizontal bubble level 112 and a vertical recess to hold a vertical bubble level 114. The recesses may be spaced in a central area of the back of the plate for ease of viewing. In an embodiment, a layer of transparent material, e.g., plastic or glass, may be provided over the back 110 of the plate 100 to protect the bubble levels and/or for aesthetic purposes.

Figure shows an alternate view of the plate 100, including a dovetail 120 to engage with the clamp body.

The bubble levels may be slightly curved glass vials with a constant inner diameter at each viewing point. Typically, the vials are incompletely filled with a liquid, usually a colored alcohol, in a desired orientation and sealed, leaving a bubble in the tube. At slight inclinations the bubble travels away from a center position, usually marked with lines approximating the diameter of the bubble.

In an embodiment, the plate may be milled from hard-anodized aluminum, which may then be colored or otherwise treated if desired. The two recesses in the back 110 of the plate may be milled into the aluminum, and the bubble levels inserted. The bubble levels may be secured using a press-fit, adhesive, or other method.

Other materials may be used for the for the construction of the plate, including other metals or, for example, hard plastics. Depending on the material, the plate may constructed using one or several different fabrication methods, including for example, milling, molding, or 3D printing.

FIG. 3 shows how a camera 130 may be mounted on the plate 100. As shown in FIG. 3, the bubble levels 112, 114 are clearly visible to the user when adjusting the plate 100.

As shown in FIG. 4, the plate 100 may be attached to a ballhead tripod mount 200, although the plate may also be used with other types of mounts and stands. A ballhead tripod mount uses a ball and socket type joint for orientation control. The ball 202 sits in a socket 204, which can be tightened to lock the ball in place. A stem 206 extends from the ball 208 which terminates at the head mount 208. A control arm 210 extends from the head mount to control movement of the ball in the socket to allow the user to properly align the camera. The ballhead tripod mount may also include a tension control to tighten or loosen the ball joint in order to prevent or allow movement of the attached device.

In operation, the user may adjust the level of the position of the head mount on the ballhead tripod mount until both the vertical and horizontal bubble levels are centered in the alignment markers for both vertical and horizontal orientations.

In alternate embodiments, the plate 100 may have different widths, depending on the type of camera, for example, 40 mm, 60 mm, or 85 mm widths. As described above, different materials and fabrication techniques may be used to construct the plate. Furthermore, the level indicators, although described as fluid-based, may be employed using other leveling technologies.

The principal features of this invention may be employed in various embodiments without departing from the scope of the invention. The specific embodiments discussed herein are merely illustrative of specific ways to make and use the invention and do not delimit the scope of the invention.

1. A camera mounting plate comprising:
a top surface adapted to receive a camera,
a plurality of sides extending vertically from the top surface, one of said sides including a ridge to secure a rear portion of the camera; and
a plurality of leveling displays in the side including the ridge.

2. The camera mounting plate of claim 1, wherein the plate comprises an arca-type plate.

3. The camera mounting plate of claim 1, wherein the plurality of leveling displays comprise bubble levels.

4. The camera mounting plate of claim 3, wherein the bubble levels comprise a horizontally oriented bubble level and a vertically oriented bubble level.

5. The camera mounting plate of claim 1, wherein the top surface further comprises one or more rubberized sections.
